(19) United States
(12) Patent Application Publication
(10) Pub. No.: US 2005/0229511 A1
(43) Pub. Date: Oct. 20, 2005

(54) Opening-limiting device for windows

(75) Inventor: Aimone Balbo Di Vinadio, Torino (IT)

Correspondence Address: HESLIN ROTHENBERG FARLEY & MESITI PC, 5 COLUMBIA CIRCLE, ALBANY, NY, 12203, US

(73) Assignee: SAVIO S.p.A., Chiusa San Michele (Torino) (IT)

(21) Appl. No.: 11/104,823

(22) Filed: Apr. 13, 2005

(30) Foreign Application Priority Data
Apr. 14, 2004 (IT) TO2004A000228

(51) Int. Cl. E06B 1/04

(52) U.S. Cl. 52/213; 52/217

(57) ABSTRACT

An opening-limiting device for windows, comprising a telescopic arm and two connection elements articulated to the opposite ends of the telescopic arm. The telescopic arm comprises two identical telescopic elements, each of them having a guiding portion engaging slidingly longitudinal edges of the other telescopic element.

### CROSS-REFERENCE TO RELATED APPLICATIONS

This application claims priority from Italian Patent Application No. TO2004A000228 filed on Apr. 14, 2004, the entire disclosure of which is incorporated herein by reference.

### DESCRIPTION

The present invention relates to an opening-limiting device for windows, which is used for limiting the opening degree of articulated windows turning around a vertical or horizontal axis.

### BACKGROUND ART

Opening-limiting devices as are available on the market generally belong to two classes. A first class includes devices having an arm with a fixed length articulated on a first end to be connection element fastened to the window frame. A second end of the arm is articulated to a block sliding in a window profile. A drawback of such opening-limiting devices consists in that during use there can be highly variable tolerances between the sliding block of the opening-limiting device and the window profile. As a matter of fact, manufacturers of opening-limiting devices cannot control in any way manufacturing tolerances of window profiles. As a consequence, coupling tolerance between sliding block and profile can be too narrow thus resulting in sliding difficulty for the block, or too broad with too large gaps between the opening-limiting device and the window. Paint applied onto window aluminum profiles results in a further variable affecting coupling tolerances between the sliding block and the profile, and the continuous sliding of the block with respect to the profile can cause a removal of the paint layer on the profile.

A second class of opening-limiting devices comprises a telescopic arm articulated on both ends to connection means fastened to the frame and to the window. The telescopic arm comprises a first element with C-shaped section and a second element mounted slidingly inside the first element.

The drawback of opening-limiting devices belonging to this second class consists in that the telescopic arm comprises two structurally different elements requiring two different manufacturing dies. Moreover, such devices should be equipped with a stop for preventing the mutual disconnection between said two telescopic elements. Opening-limiting devices of this second type as are available on the market are quite thick, which is incompatible with the standard unified sizes of aluminum profiles for windows. As a consequence, opening-limiting devices of this second type can be used only with specific window profiles.

### SUMMARY OF THE INVENTION

The present invention aims at supplying an opening-limiting device enabling to overcome the drawbacks of known solutions.

According to the present invention, such aim is achieved by an opening-limiting device having the characteristics listed in the claims.

### BRIEF DESCRIPTION OF THE DRAWINGS

The present invention will now be described in further detail with reference to the accompanying drawings, supplied as a mere non-limiting example, in which:

FIGS. 1 and 2 are perspective views from different angles of an opening-limiting device according to the present invention;

FIGS. 3 and 4 are perspective views showing the assembly of the telescopic elements of the opening-limiting device according to the invention;

FIGS. 5 and 6 are perspective views corresponding to FIGS. 5 and 6 from a different angle;

FIG. 7 is a longitudinal section along line VII-VII of FIG. 2;

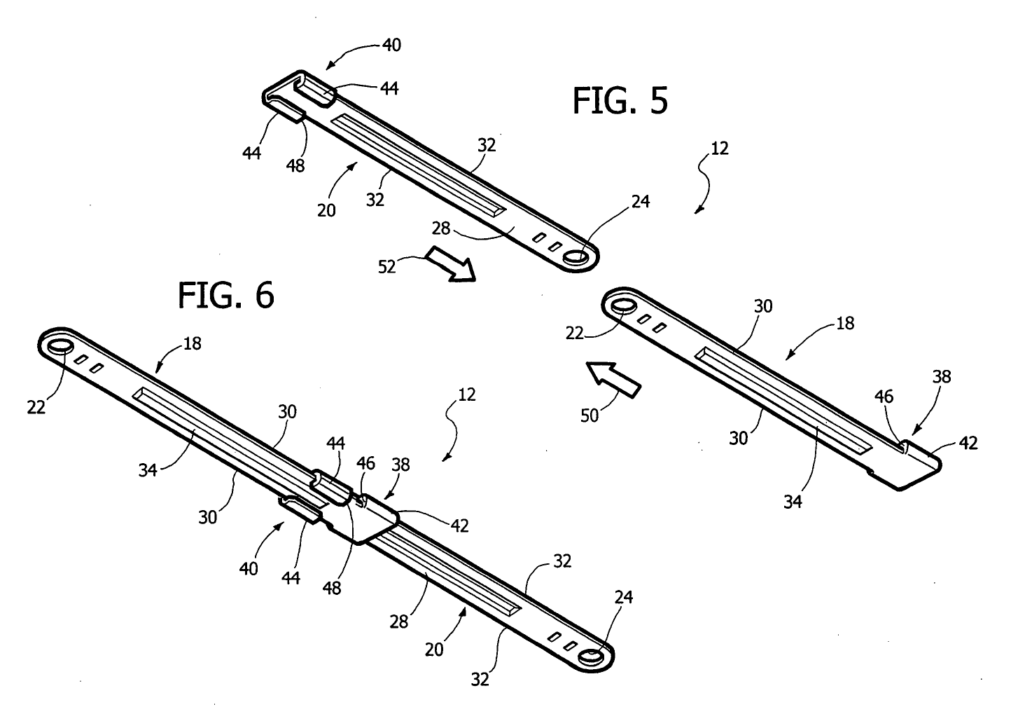

FIG. 8 is an enlarged cross-sectional view along line VIII-VIII of FIG. 2; and

FIGS. 9 and 10 are perspective views on a larger scale and from a different angle of the part marked with arrow IX in FIG. 2.

### DETAILED DESCRIPTION OF THE DRAWINGS

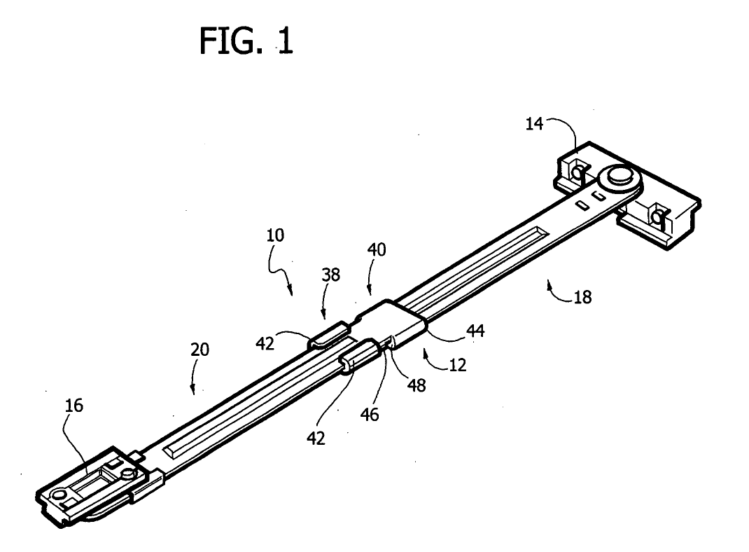

With reference to FIGS. 1 and 2, number 10 refers to an opening-limiting device for articulated windows, which can be used both for windows turning around a vertical axis and for windows turning around a horizontal axis. The device 10 comprises a telescopic arm 12 and two connection elements 14, 16 articulated around parallel axes to the opposite ends of the telescopic arm 12. The connection elements 14, 16 are designed to be fastened to a fixed frame and to a window articulated to said frame. The connection elements 14, 16 are shaped so as to be housed inside cavities of standardized aluminum profiles for doors and windows.

The telescopic arm 12 comprises two identical telescopic elements 18, 20. Each telescopic element 18, 20 is made up of a metal strip, preferably of stainless steel, with a thickness of 2.5 or 3 mm.

Each of the two telescopic elements 18, 20 is equipped on a first end with a hole 22, 24 for articulating the corresponding connection element 14, 16. Each telescopic element 18, 20 has a sliding surface 26, 28 having parallel longitudinal edges 30, 32. The sliding surfaces 26, 28 of the two telescopic elements 18, 20 are in mutual contact.

Preferably, each telescopic element 18, 20 has a longitudinal stiffening rib 34, 36 projecting from the surface opposite the sliding surface 26, 28. On the sliding surfaces 26, 28 longitudinal hollows are formed on the corresponding ribs 34, 36.

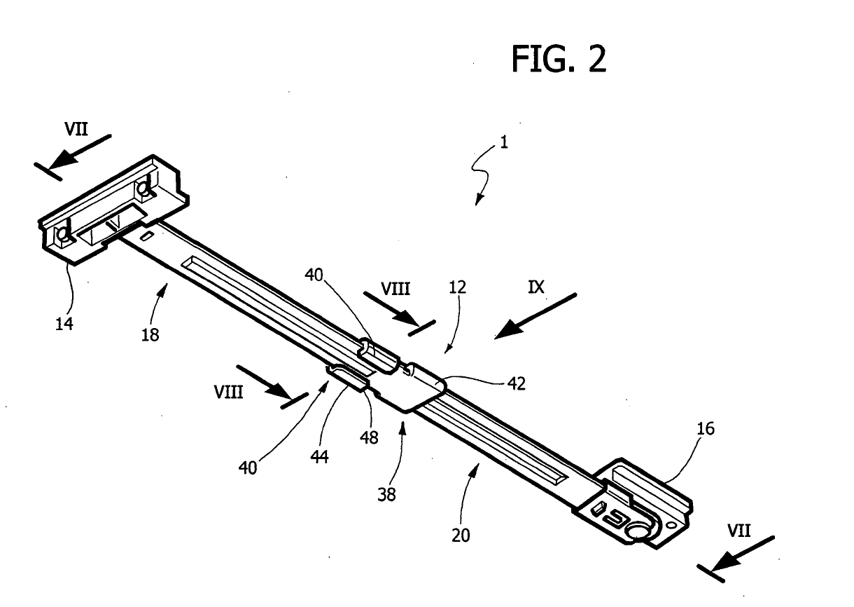

Still referring to FIGS. 3 to 6, each telescopic element 18, 20 is provided on the end opposite the one with the hole 22, 24 with a guiding portion 38, 40 made up of two substantially C-bent lateral extensions 42, 44. The guiding portions 38, 40 are provided with corresponding stop surfaces 46, 48 made up of the inner front surfaces of the C-bent lateral extensions 42, 44.

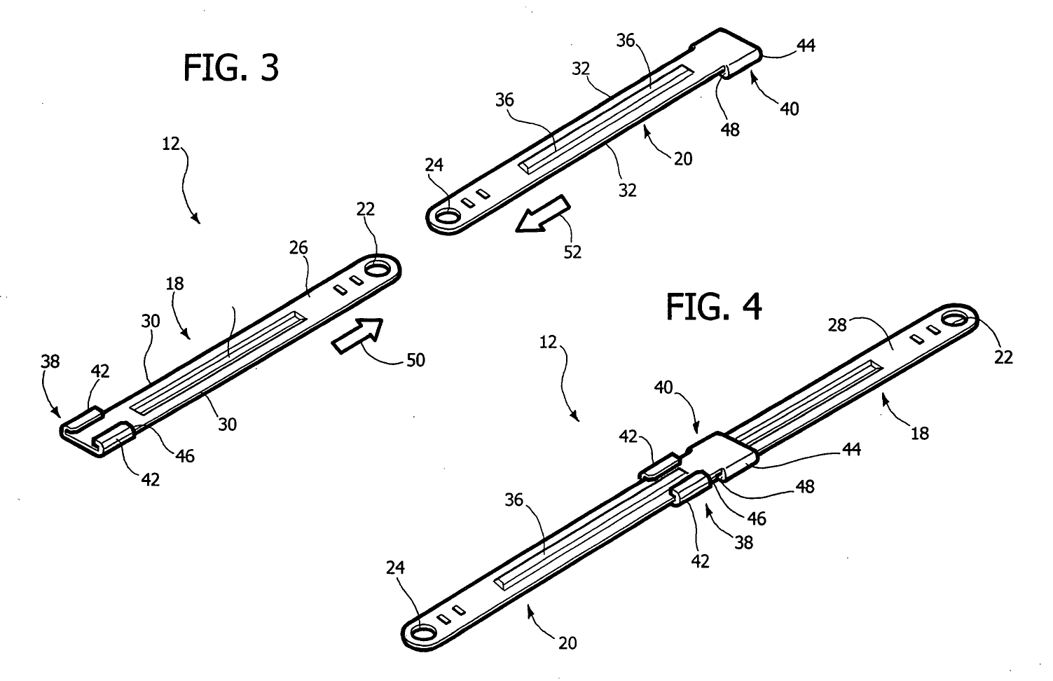

FIGS. 3, 4 and 5, 6 show how the two identical telescopic elements 18, 20 are assembled one to the other. As shown in FIGS. 3 and 5, the two elements 18, 20 are placed one opposite the other, i.e. with their sliding surfaces 26, 28 facing each other. The two telescopic elements 18, 20 are placed one beside the other in the direction indicated by arrows 50, 52. The lateral edges 30 of the first telescopic element 18 are inserted between the bent lateral extensions 44 of the guiding portion 40 of the second telescopic element 20 and, in the same way, the lateral edges 32 of the second telescopic element 20 are inserted between the bent lateral extensions 42 of the guiding portion 38 of the first telescopic element 18. FIGS. 4 and 6 show the two telescopic elements 18, 20 in assembled position.

The relative movement between the telescopic elements 18, 20 ends when the corresponding stop surfaces 46, 48 abut against each other. Said stop surfaces define in their mutual contact position the condition of maximum extension of the telescopic arm 12.

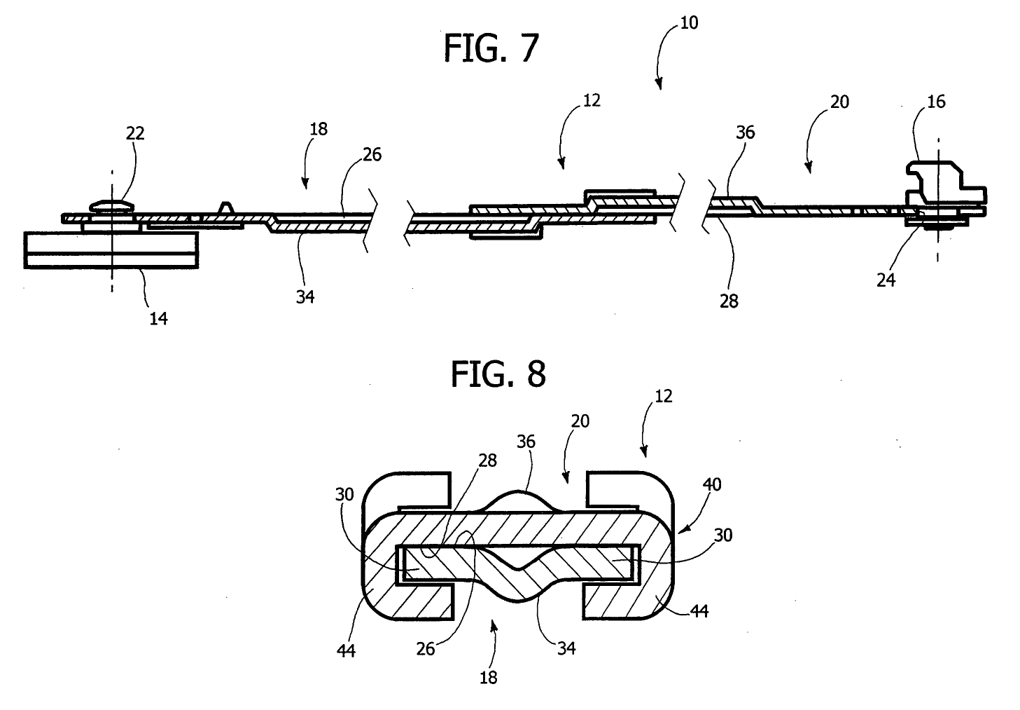

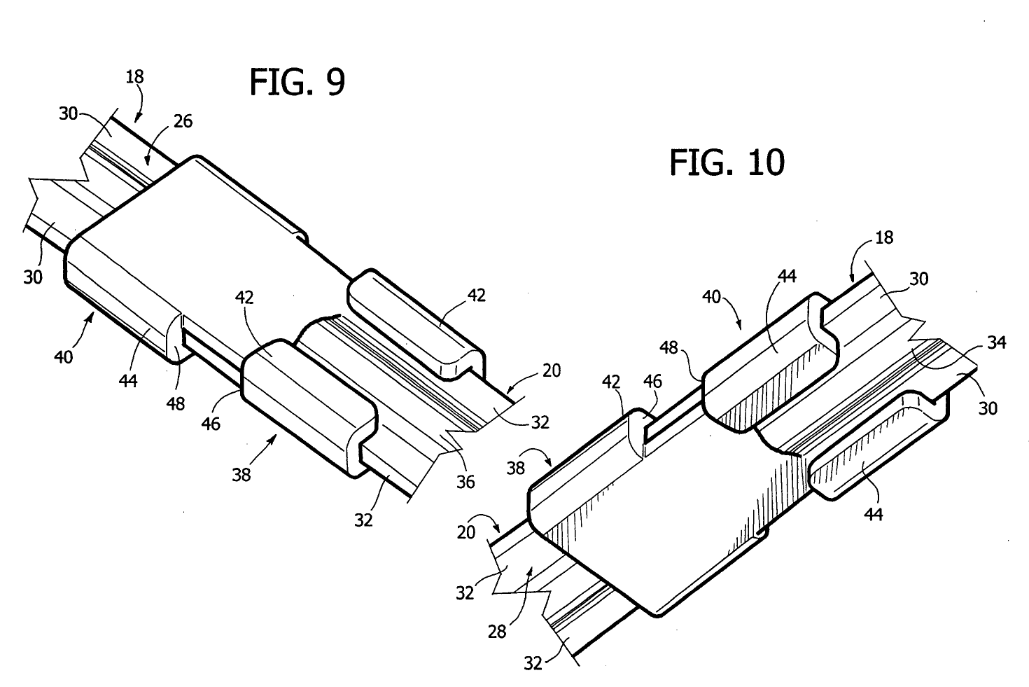

As shown in FIGS. 8, 9 and 10, the lateral edges 30, 32 of each of the telescopic elements 18, 20 are guided between the guiding portions 40, 38 of the other telescopic element. The stiffening ribs 34, 36 extend in the open space between the lateral extensions 42, 44 of the guiding portions 38, 40.

The solution according to the present invention allows to use two identical telescopic elements 18, 20. Only one manufacturing equipment made up of a die for steel sheets is thus required for said elements. The tolerances related to relative sliding between the telescopic elements 18, 20 can be accurately controlled and the global thickness of the telescopic arm 12 is very similar to the thickness of the opening-limiting devices whose arm has a fixed length. The device according to the present invention can be used for windows with standardized profiles in which the maximum distance between the facing profiles of the window and of the frame is of 11.5 mm. The opening-limiting device according to the present invention is assembled simply and rapidly and without the need for tools. Moreover, no auxiliary elements for forming a stop for limiting the mutual departing stroke of the telescopic elements are required, since the stop and stroke-end function is performed by the guiding portions 38, 40.

Obviously, though the basic idea of the invention remains the same, construction details and embodiments can widely vary with respect to what has been described and shown, though without leaving the framework of the invention as defined in the following claims.

1. An opening-limiting device for windows, comprising a telescopic arm and two connection elements articulated to the opposite ends of the telescopic arm, wherein the telescopic arm comprises two identical telescopic elements, each of them having a guiding portion engaging slidingly longitudinal edges of the other telescopic element.

2. The device according to claim 1, wherein the guiding portion of each of said telescopic elements comprises two substantially C-bent lateral extensions.

3. The device according to claim 1, wherein each of said guiding portions has a stop surface configured to abut against the stop surface of the other telescopic element in the position of maximum extension of the telescopic arm.

4. The device according to claim 1, wherein each of said telescopic elements has a sliding surface in contact with the sliding surface of the other telescopic element.

5. The device according to claim 4, characterized in that each of said telescopic elements is provided with a longitudinal stiffening rib projecting from the opposite side of said sliding surface.
